(19) United States
(12) Patent Application Publication
(10) Pub. No.: US 2011/0093511 A1
(43) Pub. Date: Apr. 21, 2011

(54) SYSTEM AND METHOD FOR AGGREGATING DATA

(76) Inventors: Gunnar D. Tapper, Florissant, CO (US); David W. Birdsall, Santa Clara, CA (US); Carol Jean Pearson, Portland, OR (US); Paul E. Denzinger, Aurora, OH (US); Chantal Tremblay, Notre-Dame-De-La-Merci (CA)

(21) Appl. No.: 12/603,020

(22) Filed: Oct. 21, 2009

(51) Int. Cl. G06F 17/30; G06F 7/00

(52) U.S. Cl. 707/803; 707/E17.044; 707/E17.136

(57) ABSTRACT

There is provided a computer-implemented method of aggregating data. An exemplary method comprises receiving an aggregation scheme and generating numerous first aggregations by aggregating data at a first level of granularity. The data may be associated with a time and stored in a first table. Further, generating the numerous first aggregations may be based on the time and the aggregation scheme. The exemplary method further comprises generating a second aggregation by aggregating the first aggregations at a second level of granularity based on the aggregation scheme. The second level of granularity may comprise the first level of granularity.

### BACKGROUND

Historical data may be aggregated to provide information used for trend analysis. Aggregation may also be performed in order to reduce the amount of data stored on disk, and to “pre-aggregate” result sets to provide robust query responsiveness.

Most models for reporting on historical data use a set of tables that contain detailed data covering a limited time frame. Such detailed data may only be retained for a limited period of time. Because storage space is not unlimited, the aged data may be deleted to make room for more current data. As such, when data ages beyond a certain time period, measured in days or weeks, the aged data may be deleted from the database.

In other models, the tables containing detailed data may be augmented with a set of tables that implement additional time dimensions that may provide a historical representation of the detailed data. The historical data may be stored in the form of aggregations on a specific time dimension such as daily, weekly, and the like. In this model, each additional table may have specific aging algorithms for each level of aggregation, such as one algorithm for daily data, one algorithm for weekly data, and so on.

### BRIEF DESCRIPTION OF THE DRAWINGS

Certain exemplary embodiments are described in the following detailed description and in reference to the drawings, in which:

FIG. 1 is a block diagram of a system adapted to aggregate data according to an exemplary embodiment of the present invention;

FIG. 2 is a process flow diagram showing a computer-implemented method for aggregating data according to an exemplary embodiment of the present invention;

FIG. 3 is a block diagram of tables that may be used in the computer-implemented method for aggregating data according to an exemplary embodiment of the present invention; and

FIG. 4 is a block diagram showing a tangible, machine-readable medium that stores code adapted to aggregate data according to an exemplary embodiment of the present invention.

### DETAILED DESCRIPTION

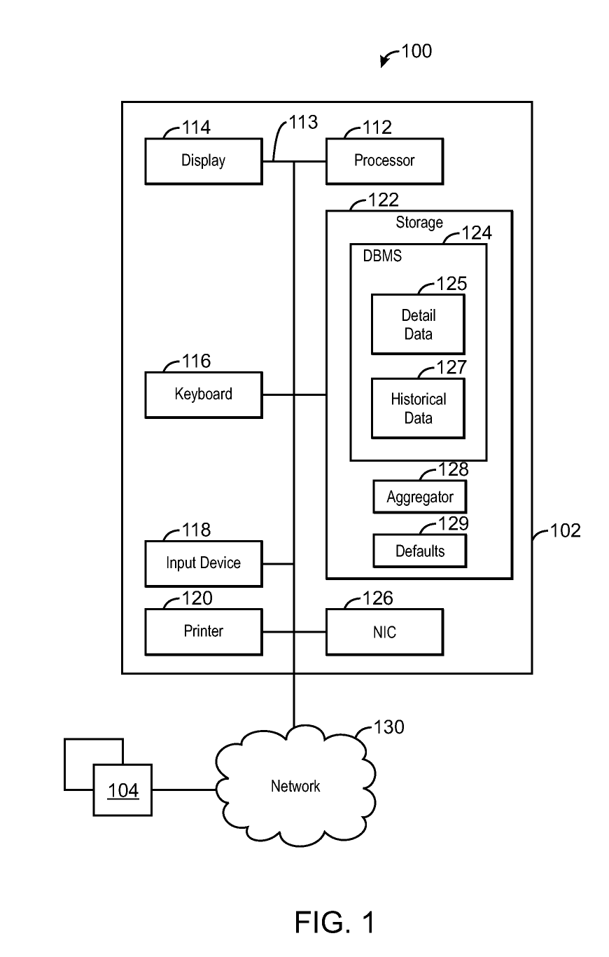

FIG. 1 is a block diagram of a system adapted to aggregate data according to an exemplary embodiment of the present invention. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium or a combination of both hardware and software elements. Additionally, the functional blocks and devices of the system 100 are but one example of functional blocks and devices that may be implemented in an exemplary embodiment of the present invention. Those of ordinary skill in the art would readily be able to define specific functional blocks based on design considerations for a particular electronic device.

The system 100 may include a database server 102, and one or more client computers 104, in communication over a network 130. As illustrated in FIG. 1A, the database server 102 may include a processor 112 which may be connected through a bus 113 to a display 114, a keyboard 116, one or more input devices 118, and an output device, such as a printer 120. The input devices 118 may include devices such as a mouse or touch screen.

The database server 102 may also be connected through the bus 113 to a network interface card (NIC) 126. The NIC 126 may connect the database server 102 to the network 130. The network 130 may be a local area network (LAN), a wide area network (WAN), or another network configuration. The network 130 may include routers, switches, modems, or any other kind of interface device used for interconnection.

Through the network 130, several client computers 104 may connect to the database server 102. The client computers 104 may be similarly structured as the database server 102, with exception to the storage of a database management system (DBMS) 124 on the database server 102. In an exemplary embodiment, the client computers 104 may be used to submit queries to the database server 102 for execution by the DBMS 124.

The database server 102 may have other units operatively coupled to the processor 112 through the bus 113. These units may include tangible, machine-readable storage media, such as a storage 122. The storage 122 may include media for the long-term storage of operating software and data, such as hard drives. The storage 122 may also include other types of tangible, machine-readable media, such as read-only memory (ROM), random access memory (RAM), and cache memory. The storage 122 may include the software used in exemplary embodiments of the present techniques.

The storage 122 may include the DBMS 124, a defaults table 129, and an aggregator 128. The DBMS 124 may be a set of computer programs that controls the creation, maintenance, and use of databases by an organization and its end users.

The DBMS 124 may include detail data 125 and historical data 127. The detail data 125 may be a database table that includes data as configured by the organization and its end users. The historical data 127 may be a database table that includes aggregations of the detail data 125. For example, the detail data 125 may include sales data for a business unit. In such a scenario, the historical data 127 may include aggregations of the sales data at multiple levels of granularity.

The levels of granularity may be time-based. Using the sales data example, the historical data 128 may include aggregations of sales data at hourly, daily, and higher levels of granularity.

The aggregator 128 may generate the historical data 127 from both the detail data 125 (for the lowest level of granularity) and the actual historical data 127 (for higher levels of granularity). For example, the detail data 125 may include records of individual sales, recorded throughout the business day. The aggregator 128 may aggregate the individual sales records into hourly sales data, and store the hourly sales data in the historical data 127.

Over the course of several days, the aggregator 128 may aggregate the hourly sales data (stored in the historical data 127) into daily sales data, which may also be stored in the historical data 127. The aggregator 128 may subsequently aggregate the historical data 127 at higher levels of granularity, such as weekly, monthly, quarterly, yearly, and the like.

The defaults 129 may be a database table that specifies details about an aggregation scheme that the aggregator 128 may use in creating the historical data 127. For example, the aggregation scheme may specify all the levels of granularity to be aggregated in the historical data 127. In an exemplary embodiment of the invention, the user may specify the aggregation scheme.

In an exemplary embodiment of the invention, the aggregator 128 may operate in real-time. In this manner, the aggregator 128 may aggregate for an hourly level of granularity at the conclusion of every hour, a daily level of granularity at the end of every day, and so on.

Additionally, the aggregator 128 may age the detail data 125 and the historical data 127. In another exemplary embodiment of the invention, the aggregator 128 may age the aggregated data according to the aggregation scheme specified in the defaults 129. For example, the aggregation scheme may specify that data may be deleted once the data is aggregated. For example, once the detail data 125 is aggregated into hourly data, the detail data 125 may be deleted. Similarly, once the hourly data is aggregated into daily data, the hourly data may be deleted from the historical data 127.

In another exemplary embodiment of the invention, the aggregation scheme may specify different aging periods depending on the level of granularity for the particular aggregation. For example, the hourly data may be retained for up to four weeks before being deleted. Daily data may be retained up to four months before being deleted. Weekly data may be retained up to four quarters before being deleted. Monthly data may be retained up to two years before being deleted. Quarterly data may be retained up to four years before being deleted. Yearly data may be retained according to a customer's preferences, even indefinitely.

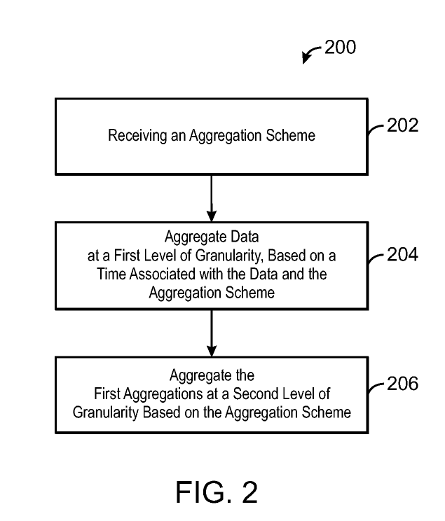

FIG. 2 is a process flow diagram showing a computer-implemented method for aggregating data according to an exemplary embodiment of the present invention. The method is generally referred to by the reference number 200, and may be performed by the aggregator 128.

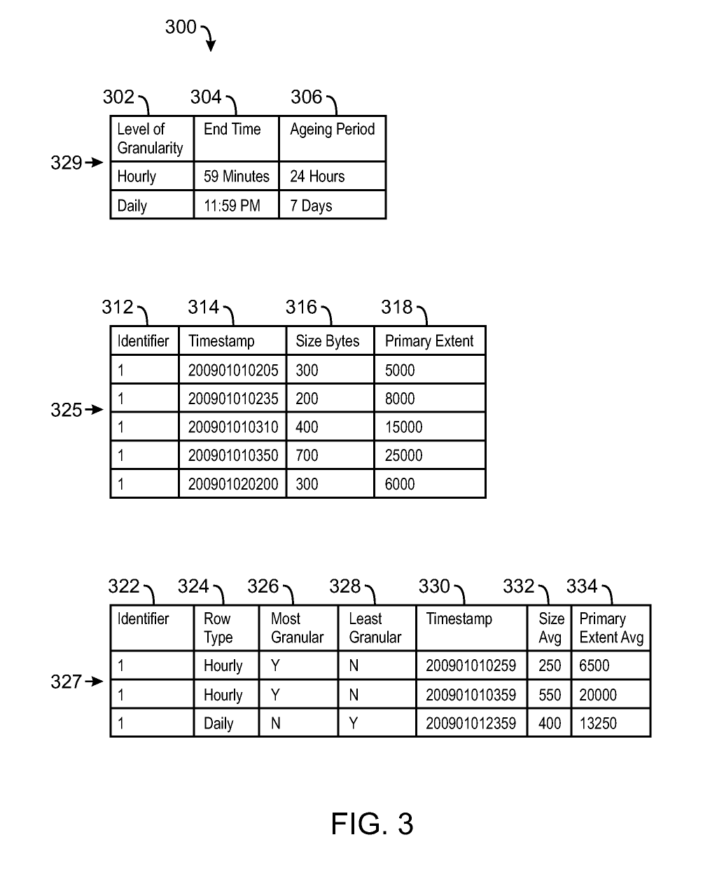

The method 200 is described with reference to FIG. 3, which is a block diagram of tables 300 that may be used in the computer-implemented method for aggregating the detail data 125 according to an exemplary embodiment of the present invention. It should be understood that the process flow diagram for method 300 is not intended to indicate a particular order of execution.

The method may begin at block 202. At block 202, the aggregator 128 may receive an aggregation scheme. The defaults table 329 illustrates an example of an aggregation scheme. The defaults table 329 may include columns for a level of granularity 302, an end time 304, and an aging period 306.

The level of granularity 302 may specify all levels at which the aggregator 128 performs aggregations. In an exemplary embodiment of the invention, each subsequent level of granularity may contain the preceding levels of granularity.

For example, the defaults table 329 includes two rows, one for an hourly level of granularity, and one for a daily level of aggregation. The daily level of granularity may comprise multiple hourly levels of granularity. Similarly, a weekly level of granularity may contain the daily level of granularity, and so on.

In the exemplary embodiment shown in FIG. 3, the defaults table 329 includes two rows, indicating two levels of granularity for the aggregation scheme in this example. It should be noted that the defaults table 329 includes two rows merely for the purpose of explanation. In an exemplary embodiment of the invention, the aggregation scheme may include additional levels of granularity.

The end time 304 may specify a cut-off time for a particular period of aggregation. For example, the hourly row includes an end time 304 of 59 minutes. As such, the aggregator 128 may aggregator hourly data in segments beginning at minute zero, and ending at minute 59. For example, hourly sales data recorded between 1:00 pm and 1:59 pm may be aggregated into a single row of historical data 127. Similarly, hourly sales data recorded between 2:00 and 2:59 may be aggregated into a single row of historical data 127, and so on.

The aging period 306 may specify how long data is permitted to age before being deleted. For example, the first row of defaults table 329 specifies an aging period 306 of 24 hours. As such, the hourly data may be retained for 24 hours before deletion. The second row of defaults table 329 specifies an aging period 306 of seven days. Accordingly, the daily data may be retained for seven days before being deleted.

At block 204, the aggregator 128 may aggregate data at a first level of granularity. The aggregation may be based on the aggregation scheme and a time associated with the data. In this example, the first level of granularity specified in defaults table 329 is hourly.

The detail table 325 represents the detail data 125 to be aggregated. The detail table 325 includes 5 rows of detail data 125 regarding a computer disk management system. The detail table 325 includes columns for an identifier 312, timestamp 314, size in bytes 316, and a primary extent 318.

The identifier 312 may be used to uniquely identify a disk partition in the computer disk management system. The timestamp 314 may indicate a time at which the information stored in each row is current. The size in bytes 316 may indicate the size of a disk partition. The primary extent 318 may indicate the size of the primary extension of the disk partition. Each row in the detail table 325 may indicate a change in the data about the disk partition identified as 1 by the identifier 312.

A historical table 327 represents the historical data 127 that contains the aggregated data. The historical table 327 includes columns for an identifier 322, row type 324, most granular 326, least granular 328, timestamp 330, size average (avg) 332, and primary extent avg 334. The identifier 322 may uniquely identify the data aggregated in the detail table 325. The row type 324 may identify the level of granularity for a particular aggregation. The timestamp 330 may identify a time when the aggregator 128 created the particular row.

The most granular 326 and least granular 328 columns may be flags identifying whether or not the level of granularity represents the highest and lowest levels of granularity in a particular aggregation scheme. The most granular 326 column may be set to true when a rows of a particular level of granularity is created. Then when the row is aggregated into a higher level of granularity, the most granular column may be set to false.

The size avg 332 and primary extent avg 334 may be statistics about the average of size in bytes 316 and primary extent 318 columns in the detail table 325. In an exemplary embodiment of the invention, the historical data 127 may include other statistics about data in the detail data 125. For example, the historical data 127 may include total values, minimum values, maximum values, median values, mode values, and the like.

As shown, the historical table 327 includes two rows for hourly aggregations: 1) for 2:00 a.m. on Jan. 1, 2009, and 2) for 3:00 a.m. on Jan. 1, 2009. Additionally, the historical table 327 includes a row for a daily aggregation for Jan. 1, 2009. In this example, the daily aggregation represents an aggregation of the two hourly rows for Jan. 1, 2009.

In an exemplary embodiment of the invention, when a period for a particular level of granularity does not exist, the previous row's data may be used. In this manner, holes in data may be filled by assuming a similarity in bordering periods of time. For example, using the example of historical table 327, if the daily aggregation for 3:00 a.m. were missing, the daily aggregation for 2:00 a.m. may be used instead.

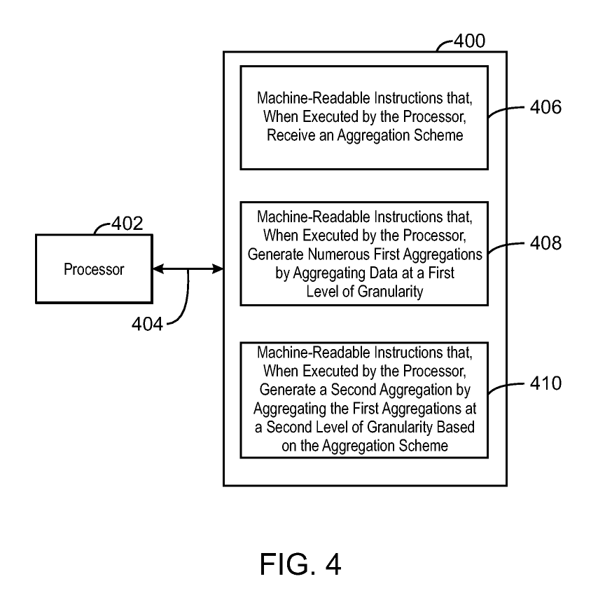

FIG. 4 is a block diagram showing a tangible, machine-readable medium that stores code adapted to aggregate the detail data 125 according to an exemplary embodiment of the present invention. The tangible, machine-readable medium is generally referred to by the reference number 400. The tangible, machine-readable medium 400 may correspond to any typical storage device that stores computer-implemented instructions, such as programming code or the like.

Moreover, tangible, machine-readable medium 400 may be included in the storage 122 shown in FIG. 1. When read and executed by a processor 402, the instructions stored on the tangible, machine-readable medium 400 are adapted to cause the processor 402 to aggregate the detail data 125.

A region 406 of the tangible, machine-readable medium 400 stores machine-readable instructions that, when executed by the processor 402, receive an aggregation scheme.

A region 408 of the tangible, machine-readable medium 400 stores machine-readable instructions that, when executed by the processor 402, generate numerous first aggregations by aggregating data at a first level of granularity.

A region 410 of the tangible, machine-readable medium 400 stores machine-readable instructions that, when executed by the processor 402, generate a second aggregation by aggregating the first aggregations at a second level of granularity based on the aggregation scheme.

What is claimed is:

1. A computer-implemented method of aggregating detail data, comprising:
receiving an aggregation scheme;
generating numerous first aggregations by aggregating data at a first level of granularity, wherein the data is associated with a time and stored in a first table, and wherein generating the numerous first aggregations is based on the time and the aggregation scheme; and
generating a second aggregation by aggregating the first aggregations at a second level of granularity based on the aggregation scheme, wherein the second level of granularity comprises the first level of granularity.

2. The method recited in claim 1, comprising:
storing the first aggregations in a second table, thereby generating numerous first rows; and
storing the second aggregation in the second table, thereby generating a second row.

3. The method recited in claim 2, wherein the first rows specify the first level of granularity, and the second row specifies the second level of granularity.

4. The method recited in claim 2, wherein the first rows comprise an indicator that the first level of granularity is a lowest level of granularity; and the second row comprises an indicator that the second level of granularity is a highest level of granularity.

5. The method recited in claim 1, wherein the aggregation scheme specifies:
the first level of granularity;
the second level of granularity;
a first end time at the first level of aggregation;
a second end time at the second level of aggregation;
a first overlap period for the first aggregations;
a second overlap period for the second aggregation; or
combinations thereof.

6. The method recited in claim 5, wherein generating the first aggregations comprises selecting the data from the first table, wherein the time is associated with a period of time ending at the first end time, and wherein generating the second aggregation comprises selecting the first aggregations from the second table, wherein the time is associated with a period of time ending at the second end time.

7. The method recited in claim 5, comprising:
deleting the data from the first table after the first overlap period; and
deleting the first aggregations from the second table after the second overlap period.

8. The method recited in claim 5, wherein the first end time is specified by an ISO8601 standard.

9. The method recited in claim 1, wherein the first aggregations comprise one of:
a total of the aggregated data;
an average of the aggregated data;
a minimum of the aggregated data;
a maximum of the aggregated data; or
combinations thereof.

10. The method recited in claim 2, comprising generating a result set from the second table, wherein the result set comprises the first aggregations and the second aggregation.

11. The method recited in claim 1, wherein the first level of aggregation comprises one of:
hourly;
daily;
weekly;
monthly; or
quarterly.

12. The method recited in claim 1, wherein the second level of aggregation comprises one of:
daily;
weekly;
monthly;
quarterly; or
yearly.

13. A computer system for executing a query plan against a database, the computer system comprising:
a processor that is adapted to execute stored instructions;
a memory device that stores instructions, the memory device comprising:
computer-implemented code adapted to receive an aggregation scheme;
computer-implemented code adapted to generate numerous first aggregations by aggregating data at a first level of granularity, wherein the data is associated with a time and stored in a first table, and wherein the numerous first aggregations are generated based on the time and the aggregation scheme; and
computer-implemented code adapted to generate a second aggregation by aggregating the first aggregations at a second level of granularity based on the aggregation scheme, wherein the second level of granularity comprises the first level of granularity.

14. The computer system recited in claim 13, comprising:
computer-implemented code adapted to store the first aggregations in a second table, thereby generating numerous first rows; and
computer-implemented code adapted to store the second aggregation in the second table, thereby generating a second row.

15. The computer system recited in claim 14, wherein the first rows specify the first level of granularity, and the second row specifies the second level of granularity.

16. The computer system recited in claim 14, wherein the first rows comprise an indicator that the first level of granularity is a lowest level of granularity; and the second row comprises an indicator that the second level of granularity is a highest level of granularity.

17. The computer system recited in claim 13, wherein the aggregation scheme specifies:
the first level of granularity;
the second level of granularity;
a first end time at the first level of aggregation;
a second end time at the second level of aggregation;
a first overlap period for the first aggregations;
a second overlap period for the second aggregation; or
combinations thereof.

18. The computer system recited in claim 17, wherein the computer-implemented code adapted to generate the first aggregations comprises computer-implemented code adapted to select the data from the first table, wherein the time is associated with a period of time ending at the first end time, and wherein generating the second aggregation comprises selecting the first aggregations from the second table, wherein the time is associated with a period of time ending at the second end time.

19. The computer system recited in claim 14, comprising computer-implemented code adapted to generate a result set from the second table, wherein the result set comprises the first aggregations and the second aggregation.

20. A tangible, machine-readable medium that stores machine-readable instructions executable by a processor to aggregate detail data, the tangible, machine-readable medium comprising:
machine-readable instructions that, when executed by the processor, receive an aggregation scheme;
machine-readable instructions that, when executed by the processor, generate numerous first aggregations by aggregating data at a first level of granularity, wherein the data is associated with a time and stored in a first table, and wherein the numerous first aggregations are generated based on the time and the aggregation scheme; and
machine-readable instructions that, when executed by the processor, generate a second aggregation by aggregating the first aggregations at a second level of granularity based on the aggregation scheme, wherein the second level of granularity comprises the first level of granularity.
